(19) United States
(12) Patent Application Publication
(10) Pub. No.: US 2017/0109683 A1
(43) Pub. Date: Apr. 20, 2017

(54) MENTOR IDENTIFICATION SYSTEM

(71) Applicant: International Business Machines Corporation, Armonk, NY (US)

(72) Inventors: Lee A. Carbonell, Flower Mound, TX (US); Tsz S. Cheng, Grand Prairie, TX (US); Jeffrey L. Edgington, Keller, TX (US); Pandian Mariadoss, Allen, TX (US)

(21) Appl. No.: 14/884,111

(22) Filed: Oct. 15, 2015

(51) Int. Cl. G06Q 10/06; G06F 17/30

(52) U.S. Cl. CPC G06Q 10/063112; G06F 17/30525; G06F 17/30528; G06F 17/30867

(57) ABSTRACT

Identifying mentors may include, responsive to receiving a mentorship request, generating search parameters, using a central request processor, from the mentorship request, and distributing the search parameters to a mentor identification processor. Identifying mentors may include selecting, from private data of the organization, a candidate mentor set of at least one candidate mentor that meets the search parameters and that has agreed to serve as a mentor, matching a candidate mentor with the mentee according to publicly accessible information retrieved for each candidate mentor, and determining whether a matched candidate mentor accepts selection for mentorship for the mentee. Identifying mentors may also include sending a notification specifying the matched candidate mentor to a device of the mentee only responsive to determining that the matched candidate mentor accepts the mentorship.

### BACKGROUND

The inventive arrangements described within this disclosure relate to identifying candidate mentors and matching the candidate mentors to mentees using existing data sources to meet specific situational requirements of the mentees.

Mentorship refers to a relationship in which a person of greater experience and/or knowledge called a mentor provides guidance to a person of lesser experience and/or knowledge called a mentee. A mentorship provides a means through which a mentor may provide knowledge, social capital, support, and the like to the mentee. A successful mentorship is beneficial and enriching for both the mentor and the mentee. Despite the many benefits of successful mentorships, finding a willing mentor with qualifications and experiences that satisfy the specific requirements of a mentee is often difficult. Moreover, a mismatched mentor-mentee relationship may lead to a poor experience for both mentor and mentee, which may discourage participation in mentorship programs.

### SUMMARY

An embodiment of present invention includes a method. The method may include, responsive to receiving a mentorship request including natural language, generating search parameters, using a central request processor, from the mentorship request, wherein the search parameters specify an identity of a mentee making the mentorship request. The method may include distributing the search parameters to a mentor identification processor, wherein the mentor identification processor is implemented for a single organization and has access to a data system of the organization, wherein the data system stores private data of the organization unavailable to the central request system or the mentee. The method may include selecting, using the mentor identification processor and from the private data of the organization, a candidate mentor set including at least one candidate mentor that meets the search parameters and that has agreed to serve as a mentor, matching, using the mentor identification processor, a candidate mentor of the candidate mentor set with the mentee according to publicly accessible information retrieved for each candidate mentor of the candidate mentor set, and determining, using the mentor identification processor, whether a matched candidate mentor accepts selection for mentorship for the mentee. The method may also include sending, using the mentor identification processor, a notification specifying the matched candidate mentor to a device of the mentee only responsive to determining that the matched candidate mentor accepts the mentorship.

Another embodiment of the present invention may include a system. The system may include a processor programmed to initiate executable operations. The executable operations may include, responsive to receiving a mentorship request including natural language, generating search parameters, using a central request processor, from the mentorship request, wherein the search parameters specify an identity of a mentee making the mentorship request. The executable operations may include distributing the search parameters to a mentor identification processor, wherein the mentor identification processor is implemented for a single organization and has access to a data system of the organization, wherein the data system stores private data of the organization unavailable to the central request system or the mentee. The executable operations may include selecting, using the mentor identification processor and from the private data of the organization, a candidate mentor set including at least one candidate mentor that meets the search parameters and that has agreed to serve as a mentor, matching, using the mentor identification processor, a candidate mentor of the candidate mentor set with the mentee according to publicly accessible information retrieved for each candidate mentor of the candidate mentor set, and determining, using the mentor identification processor, whether a matched candidate mentor accepts selection for mentorship for the mentee. The executable operations may also include sending, using the mentor identification processor, a notification specifying the matched candidate mentor to a device of the mentee only responsive to determining that the matched candidate mentor accepts the mentorship.

Another embodiment of the present invention may include a computer program product. The computer program product includes a computer readable storage medium having program code stored thereon. The program code may be executed by a processor to perform a method. The method may include, responsive to receiving a mentorship request including natural language, generating search parameters, using a central request processor, from the mentorship request, wherein the search parameters specify an identity of a mentee making the mentorship request. The method may include distributing the search parameters to a mentor identification processor, wherein the mentor identification processor is implemented for a single organization and has access to a data system of the organization, wherein the data system stores private data of the organization unavailable to the central request system or the mentee. The method may include selecting, using the mentor identification processor and from the private data of the organization, a candidate mentor set including at least one candidate mentor that meets the search parameters and that has agreed to serve as a mentor, matching, using the mentor identification processor, a candidate mentor of the candidate mentor set with the mentee according to publicly accessible information retrieved for each candidate mentor of the candidate mentor set, and determining, using the mentor identification processor, whether a matched candidate mentor accepts selection for mentorship for the mentee. The method may also include sending, using the mentor identification processor, a notification specifying the matched candidate mentor to a device of the mentee only responsive to determining that the matched candidate mentor accepts the mentorship.

### BRIEF DESCRIPTION OF THE DRAWINGS

FIG. 1 is a block diagram illustrating an exemplary network system.

FIG. 2 is a block diagram illustrating an exemplary implementation of a mentor identification processor.

FIG. 3 is a flow chart illustrating an exemplary method of mentor identification.

FIG. 4 is a block diagram illustrating an exemplary data processing system that may be used to implement the inventive arrangements described herein.

### DETAILED DESCRIPTION

The inventive arrangements described within this disclosure relate to identifying candidate mentors and matching the candidate mentors to mentees using existing data sources to meet specific situational requirements of the mentees. In accordance with the inventive arrangements described herein, a mentee, which is a user, may submit a mentorship request to a mentor identification system. The mentor identification system may process the received request and distribute the search parameters derived from the mentorship request to one or more mentor identification processors implemented at one or more different organizations.

The mentor identification processor within each of the different organizations may have access to private data of that organization that is to remain confidential and not be shared with untrusted or unknown computing systems outside of the organization. The mentor identification processor of an organization may search the private data of the organization for users, e.g., candidate mentors, who have agreed to participate in a mentorship program. The mentor identification systems effectively leverages existing data within the organization when searching for a candidate mentor that matches the requirements of the mentee.

Utilizing the existing private data of the organization while maintaining confidentiality of the private data may eliminate the need for users to register as potential mentors with the mentor identification system. Registration is often a time consuming process that requires the user to fill out lengthy and intrusive questionnaires. Removing the need for a formal registration process may increase user participation in the mentor identification system. Further, utilizing the already extensive private data of an organization may result in improved mentor-mentee matching compared to more conventional systems that attempt to match mentor profiles filled out by the potential mentors with mentees profiles.

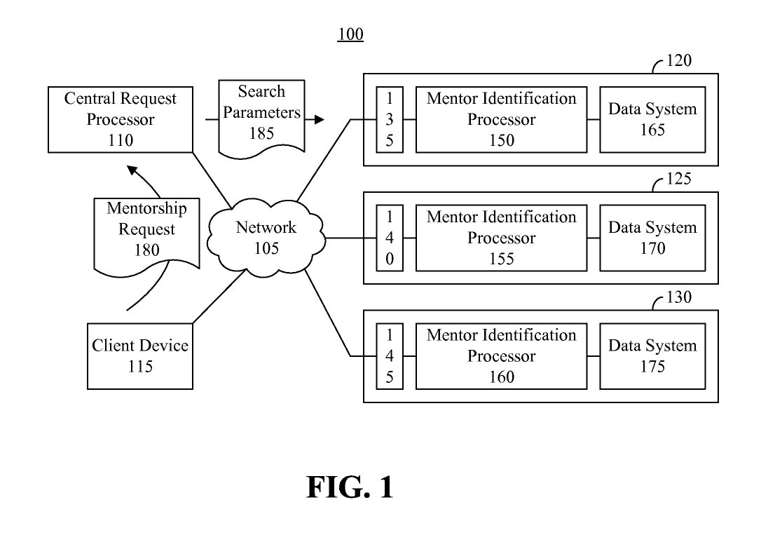

FIG. 1 is a block diagram illustrating an exemplary network system 100. Network system 100 is a network of one or more systems such as computers, communication devices, and the like, in which the illustrative embodiments may be implemented. Network system 100 may include a network 105, a central request processor 110, one or more client devices shown as client device 105, and one or more private computing networks 120, 125, and 130.

Network 105 is the medium used to provide communication links between various devices and systems connected together within network system 100. Network 105 may include connections, such as wire, wireless communication links, fiber optic cables, and the like. Network 105 may be implemented as, or include, any of a variety of different communication technologies such as an intranet, a local area network (LAN), a wide area network (WAN), a wireless network, a mobile network, a Virtual Private Network (VPN), the Internet, the Public Switched Telephone Network (PSTN), or the like.

As pictured in FIG. 1, request processor 110, client device 105, and private computing networks 125, 130, and 135 are coupled to network 105. Central request processor 110 may be implemented as a computer system or one or more networked computer systems. In one example, central request processor 110 may be implemented as a server or one or more interconnected servers. Client device 115 may be implemented as data processing systems such as a computer, a tablet computer, a mobile communication device, a handheld communication device, or the like.

Private computing networks 120, 125, and 130 may include firewalls 135, 140, and 145, mentor identification processors 150, 155, and 160, and data systems 165, 170, and 175, respectively. Private computing networks 120, 125, and 130 represent the computing infrastructure of three different organizations. The organizations may be commercial organizations, universities, governmental organizations, or the like. The term “private” within the phrase “private computing network” is not intended to infer that each organization is privately owned and/or operated, but rather that each of private computing network 120, 125, and 130 maintains control over data stored therein without sharing or sending the data to other computing systems outside of the respective private computing network. In this regard, each of private computing networks 120, 125, and 130 may include a plurality of computing nodes, network infrastructure, and the like.

As pictured, each of private computing networks 120, 125, and 130 may include one or more data systems shown as data systems 165, 170, and 175, respectively, in which confidential data is stored. Data systems 165, 170, and 175 are independent of one another. In one aspect, each of private computing networks 120, 125, and 130 may represent a domain or other network where users must be registered or have credentials to access.

As defined within this disclosure, the term “firewall” means a computing node of a communication and/or computing network designed to block unauthorized access to computing nodes belonging to the network while permitting outward communication from computing nodes belonging to the network. A firewall may monitor and control the incoming and outgoing network traffic for the network based on predetermined security rules. The firewall establishes a barrier between computing nodes of the network protected by the firewall and considered trusted and computing nodes outside of the network considered untrusted. As described herein, each of private computing networks 120, 125, and 130 may be considered and independent and different network.

Each of mentor identification processors 150, 155, and 165 may be implemented as a computer system or one or more networked computer systems. For example, each of mentor identification processors 150, 155, and 165 may be implemented as a server or one or more interconnected servers. Mentor identification processors 150, 155, and 160 may be communicatively linked to firewalls 125, 140, and 145, respectively. Further, mentor identification processors 150, 155, and 160 may be communicatively linked with data systems 165, 170, and 175, respectively.

For example, the data stored within data systems 165, 170, and/or 175 may include, but is not limited to, employment records, student records, medical records, and the like. In illustration, consider the case where private computing network 120 is for a public university. In that case, data system 165 may store student records, student transcripts, employment data for faculty and staff, and the like. In another illustration, private computing network 125 may be for a hospital. In that case, data system 170 may store medical records, employment data for medical and administrative staff, and the like. In each case, the data stored within the data system is protected and kept within the private computing system. It should be appreciated that not all users of a given network computing system 120, 125, and/or 130 may have access to all private data of data systems 165, 170, and 175, respectively.

Selected users of network computing system 120 may have access to particular items of private data while other users of network computing system 120 may have access to one or more other items of private data. As defined herein, the term “private data” means data of an organization that is confidential and not permitted to be disseminated or shared with untrusted computing nodes. Further, private data may be restricted for accessing on a per user basis based upon rights given or assigned to the user.

For purposes of description, central request processor 110 and the various mentor identification processors 150, 155, and 160, taken collectively, may form a mentorship system that attempts to find mentors for users that request mentorship, e.g., mentees. While mentor identification processors 150, 155, and 160 may implement a mentorship program that may extend across multiple organizations, each individual mentor identification processor 150, 155, and 160 is implemented as a trusted element of private computing system 120, 125, and 130, respectively. As pictured, mentor identification processor 150 is implemented behind firewall 135 and has access to data system 165 or a portion thereof. Mentor identification processor 155 is implemented behind firewall 140 and has access to data system 170 or a portion thereof. Mentor identification processor 160 is implemented behind firewall 145 and has access to data system 175 or a portion thereof.

In one embodiment, a user of client device 115, e.g., a mentee, may log into central request processor 110 to request a mentor. Client device 115 may send a mentorship request 180 to central request processor 110. In one aspect, mentorship request 180 may be specified as natural language, e.g., free form text or unstructured data. For example, the user of client device 115 may write text describing specific circumstances or a situation for which mentorship is desired into a Web-based graphical user interface, text field, or other interface element. In one aspect, mentorship request 180 specifies the mentee's requirements for a mentor. The text, along with one or more other data items may be delivered to central request processor 110 as mentorship request 180. As defined herein, a mentee is a user that submits a mentorship request such as mentorship request 180. It should be appreciated that the mentee may not be a user of private computing networks 120, 125, or 130. In this regard, the mentee does not have access to any private data stored in data systems 165, 170, and/or 175.

In another example, the user of client device 115 may speak the request into an audio interface so that the user speech may be converted to natural language by client device 115, central request processor 110, or another data processing system. While mentorship request 180 may be specified in natural language, it should be appreciated that mentorship request 180 may also include one or more other data items specified by the mentee that may be indicated through the use of other user interface elements such as drop down menus, radio buttons, or the like presented through client device 115.

Central request processor 110 may analyze mentorship request 180. In one aspect, central request processor 110 may apply natural language processing (NLP) to determine meaning from mentorship request 180. Central request processor 110, for example, may determine or generate one or more search parameters 185 from mentorship request 180.

NLP is a field of computer science, artificial intelligence, and linguistics that implements computer processes to facilitate interactions between computer systems and human (natural) languages. NLP enables computers to derive computer-understandable meaning from natural language input. The International Organization for Standardization (ISO) publishes standards for NLP, one such standard being ISO/TC37/SC4. Semantic analysis is the implementation of computer processes to generate computer-understandable representations of natural language expressions. Semantic analysis can be used to construct meaning representations, semantic understanding, anaphora resolution, presupposition projection, and quantifier scope resolution, which are known in the art. Semantic analysis is frequently used with NLP to derive computer-understandable meaning from natural language input.

Central request processor 110 may send search parameters 185 to one or more of private computing networks 120, 125, and/or 130. More particularly, central request processor 110 may send search parameters 185 to one or more of mentor identification processors 150, 155, and/or 160. In one example, central request processor 110 may be used in combination with one particular mentor identification processor. In that case, central request processor 110 may send search parameters 185 to that mentor identification processor. In another example, central request processor 110 may select one or more mentor identification processors 150, 155, and/or 160 to which search parameters 185 may be distributed based upon the content of mentorship request 180 and stored descriptions of the organizations, e.g., domains, at which mentor identification processors 150, 155, and/or 160 are installed.

In the example of FIG. 1, search parameters 185 may be distributed to private computing systems 120 and 125. For example, central request processor 110 may maintain a list of participating organizations that have implemented mentorship identification systems as described. Central request processor 110 may maintain a list of mentor identification processors 150, 155, and 160 along with a description of the organization for each mentor identification processor. Mentorship request 180 may include text that indicates the mentees desire to have a mentor from a particular business organization, e.g., the business organization of private computing network 120, and having attended a particular college, e.g., the college of private computing network 125. Central request processor 110 may select mentor identification processors 150 and 155 as being relevant to mentorship request 180 and, as such, distribute search parameters 185 to each of mentor identification processors 150 and 155.

Continuing with the example above, mentor identification processors 150 and 155 may receive search parameters 185. Each of mentor identification processors 150 and 155 may search through users of private computing networks 120 and 125, respectively, by searching data systems 165 and 170, respectively, for users that have opted into participating in a mentorship program and that have attributes that match search parameters 185. In searching for candidate mentors, mentor identification processor 150 may only search private data stored in data system 165. Similarly, mentor identification processor 155 may only search private data stored in data system 170.

Each of data systems 165, 170, and 175 stores data for the organization to which the data system belongs. Further, data systems 165, 170, and 175 do not store mentor profiles. Rather, mentor identification processors 150, 155, and 160 are configured to search structured and/or unstructured data stores represented by data systems 165, 170, and 175, respectively. In accordance with the inventive arrangements described within this disclosure, mentor identification processors 150, 155, and 160 may search the private organizational data within data systems 165, 170, and 175, respectively to locate candidate mentors without the users of the various organizations having to formally register as potential mentors. Within this disclosure, the terms “private data of an organization” and “private organizational data” are used interchangeably. The users that are searched need only give permission, or opt in. Whether a given user within an organization is suited to be a mentor and, as such, considered as a candidate mentor, depends upon the user opting in to the mentorship program and the data for the user that is already stored in the respective data systems.

Conventional mentor systems require that each user interested in being a mentor register with the mentor system. Registration typically entails that each user fill out detailed, lengthy questionnaires. The information provided by the users is used to create a profile. The profiles are used to pair mentees with the potential mentors. Because the pairing process is only as good as the information provided by the potential mentors, registration is often time consuming and onerous.

For purposes of illustration, consider an exemplary use case in which the user of client device 115, i.e., the mentee, is a college freshman from a small town and that the mentee relies on significant financial aid. The mentee may be finishing the first year of a 4 year program at a major public university. The mentee may wish to change his or her declared course of study and transfer to a different, smaller college in the same state as the major public university. The mentee is concerned about how these contemplated changes will impact the likelihood of graduating on time, the mentee's financial situation, and professional marketability upon graduation. The mentee wishes to find a mentor that has successfully gone through similar changes and that shared a similar financial background.

A conventional mentor system may generate a list of potential mentors. These potential mentors, which are presumably matched to the mentee, may be inappropriate for one or more reasons. For example, the potential mentors may not meet the specified circumstances described by the mentee, may no longer be available as a mentor, or the like. Meanwhile, another user with the following attributes may exist: recent graduate with honors, from a nearby town, and that transferred during the first or second year of college. This user may wish to serve as a mentor, but have no idea that someone with a similar set of circumstances is need of mentorship.

In other cases, individuals may be highly qualified to be a mentor and be willing to serve as a mentor, but be unwilling to go through the laborious process of registering and creating a sufficiently detailed profile. Often, the information provided through some of the more lengthy registration processes is still not sufficiently detailed to allow for precision matching of mentee and mentor. In order to obtain sufficiently detailed information, the registration process would include an unreasonably large number of questions. Moreover, the questions would likely be intrusive and overly personal. In other cases, profiles created by the mentee and/or the potential mentors may include incomplete, inaccurate, and/or false information, thereby leading to mentee and mentor mismatches. In still other cases, potential mentors may be paired with a mentee, but not be available when needed or convenient for the mentee.

Referring to the above example, the potential mentor having recently graduated with honors from a nearby town and that transferred during the first or second year of college may be located from within private data of the relevant organization. For example, the mentee may submit mentorship request 180 in natural language summarizing the above points. Central request processor 110 may develop search parameters 185 and select private computing network 125. Central request processor 110 may send search parameters 185 to private computing network 125, being a college. Mentor identification processor 155 may search the private data stored in data system 170, e.g., student transcripts, to locate the individual meeting the requirements, who has opted into participating in the mentorship program.

FIG. 1 is provided for purposes of illustration and is not intended to limit the inventive arrangements described within this disclosure. For example, network system 100 may include additional servers or systems, fewer servers or systems, additional client devices, fewer client devices, and/or other devices not shown.

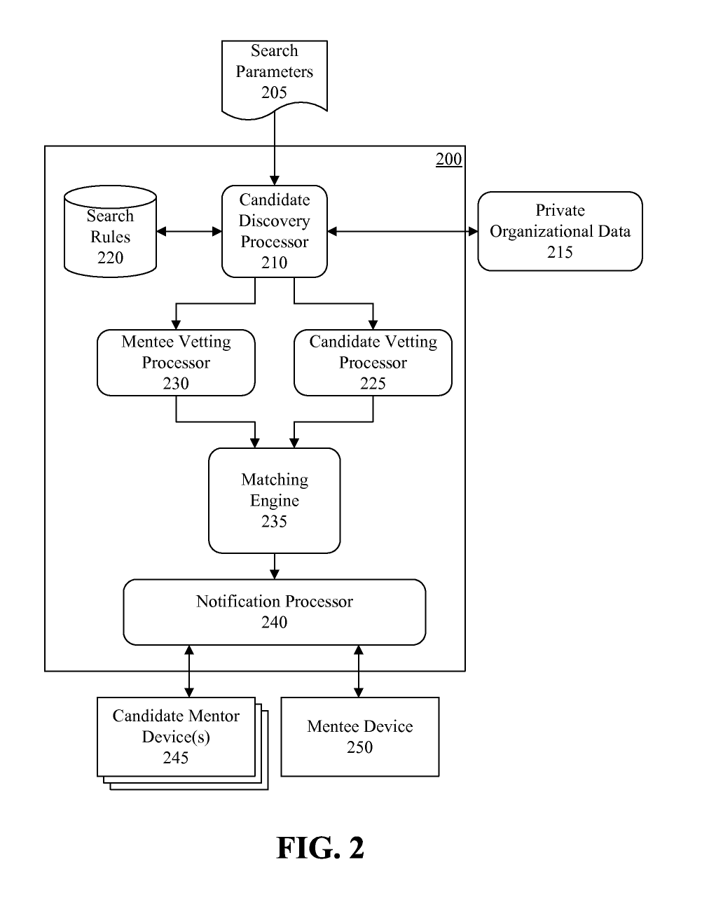

FIG. 2 is a block diagram illustrating an exemplary implementation of a mentor identification processor 200. Mentor identification processor 200 may be implemented within a data processing system within a private computing network 202 behind a firewall as previously discussed. In one arrangement, mentor identification processor 200 may leverage personal and/or private records of individuals within the particular organization in which mentor identification processor 200 is implemented. Mentor identification processor 200 may leverage this information to match mentees with users of the organization while maintaining the personal and/or private nature of the records of the users being considered. Mentor identification processor 200 may access these confidential records while ensuring that data from the records is not disseminated outside of mentor identification system 200 itself.

As pictured, a candidate discovery processor 210 may receive search parameters 205 from a central request processor. Candidate discovery processor 210 is configured to search private organizational data 215 for users that meet the criteria specified by search parameters 205. Private organizational data 215 may be the organization's private records. In one arrangement, searching performed by candidate discovery processor 210 may be confined to only those users specified within private organizational data 215 that have opted into participating in the mentorship program. In this regard, users interested in serving as a mentor within the organization within which mentor identification processor 200 is implemented do not have to undergo any formal registration process to be considered for mentoring. Instead, the users need only opt in to participating in the mentorship program.

In one aspect, candidate discovery processor 210 may mine and categorize private organization data 215. In that case, rather than querying the actual data systems of the organization responsive to receiving search parameters 205, candidate discovery processor 210 may query or search the local data caches that may be created by mining and categorizing private organization data 215. Data mining is a computer process of discovering patterns in large data sets involving methods that may include, but are not limited to, artificial intelligence, machine learning, statistics, and database systems. Data mining may be used to extract information from a data set and transform it into an understandable structure for further use.

In one arrangement, candidate discovery processor 210 may modify search parameters 205 in accordance with search rules 220. Search rules 220 may be specific to the organization in which mentor identification processor 200 is implemented. For example, each different mentor identification processor may utilize its own set of customized rules. Search rules 220 may specify various conditions such as disallowing searching based upon salary, health history, and the like. As noted, users that have not opted into the mentorship program may be excluded from the search. In another example, search rules 220 may specify that if fewer than “N” candidate mentors are found to meet search parameters 205, where N is an integer value, searching is discontinued and candidate discovery processor determines that no candidate mentors are found since the rule requirement is not met. A rule that requires at least a minimum number of candidate mentors be found as a candidate mentor set prevents mentees from fishing or searching for particular individuals as mentors.

Candidate discovery processor 210, from searching private organizational data 215, may determine a candidate mentor set that includes one or more candidate mentors that meet the criteria of search parameters 205. Candidate discovery processor 210 may provide the candidate mentor set to candidate vetting processor 225. Search parameters 205 may specify the identity of the mentee. Accordingly, candidate discovery processor 210 may send the identity of the mentee through to mentee vetting processor 230.

Candidate vetting processor 225 may query one or more publicly available data services (not shown) to obtain public information about each candidate mentor included in the candidate mentor set determined by candidate discovery processor 210. For example, candidate vetting processor 225 may query one or more data services for criminal records, professional organizational memberships, social networking services, and the like. It should be appreciated, that candidate vetting processor 225 queries publicly available data services using only identity information of the candidate mentors. Data items from private organizational data 215 other than identity, e.g., name, are not used by candidate vetting processor 225 and do not leave mentor identification processor 200. Mentee vetting processor 230 may query one or more publicly available data services to obtain public information about the mentee. Mentee vetting processor 230 may query the same or similar data services as candidate vetting processor 225.

A data service may be a Web based computing system that provides data of a particular nature responsive to received queries. A data service is “publicly available” when the data that is provided is publicly available or data in the public domain, despite the data service charging for access or requiring registration. Examples of data services may include, but are not limited to, a criminal records data service, a police records service, credit scoring service, and the like. As defined herein, a “social networking service” or site is a computing platform that allows users to build social networks or social relations among people who share similar interests, activities, backgrounds or real-life connections.

Candidate vetting processor 225 may provide results obtained for each candidate mentor of the candidate mentor set to matching engine 235. Similarly, mentee vetting processor 230 may provide results obtained from querying publicly available data services for the mentee to matching engine 235. In one aspect, matching engine 235 may search the received publicly available information for both mentee and candidate mentors for data items indicating potential safety threats. Matching engine 235, for example, may disqualify a candidate mentor responsive to identifying one or more attributes from the retrieved publicly available information that may indicate a safety concern. As an example, criminal and/or police records may indicate that an individual may not be qualified for mentorship, whether as a mentee or as a mentor. Matching engine 235 may discontinue the mentor identification process responsive to identifying one or more attributes from the publicly available information for the mentee that may indicate a safety concern.

In another aspect, matching engine 235 may search the received publicly available information for both mentee and/or candidate mentors and compare the received publicly available information with other information on hand such as private organizational data 215 to ensure accuracy. In yet another aspect, matching engine 235 may compare received publicly available information for candidate mentors with one or more of search parameters 205 to perform further filtering of candidate mentors of the candidate mentor set in an attempt to find a match for the mentee.

Matching engine 235 may select one or more of candidate mentors as a match for the mentee. Matching engine 235 may provide notification processor 240 with contact information for each selected candidate mentor and/or contact information for the mentee. Notification processor 240 may be configured to notify each matching candidate mentor that the candidate mentor was selected as a match to serve as a mentor for the mentee. For example, notification processor 240 may send a message to the device 245 of each matched candidate mentor. The message may specify the identity of the mentee and optionally one or more details and/or parameters of the mentee's mentorship request and/or search parameters 205. The message may ask the selected candidate mentor whether the selected candidate mentor would like to be a mentor to the mentee.

Notification processor 240 further awaits a response message from each of the matched candidate mentors to which a message has been sent. The response message for each candidate mentor may indicate whether the candidate mentor agrees to be a mentor for the mentee given the mentee's requirements and/or circumstances. In one arrangement, only those matched candidate mentors that provide a response message agreeing to be a mentor may be permitted to be mentors. This prevents those users that do not wish to be mentors for particular situations and/or circumstances from being proposed as a mentor to the mentee. Notification processor 240 may send a message to mentee device 250 specifying one or more or each matched candidate mentor that has agreed to become a mentor for the mentee.

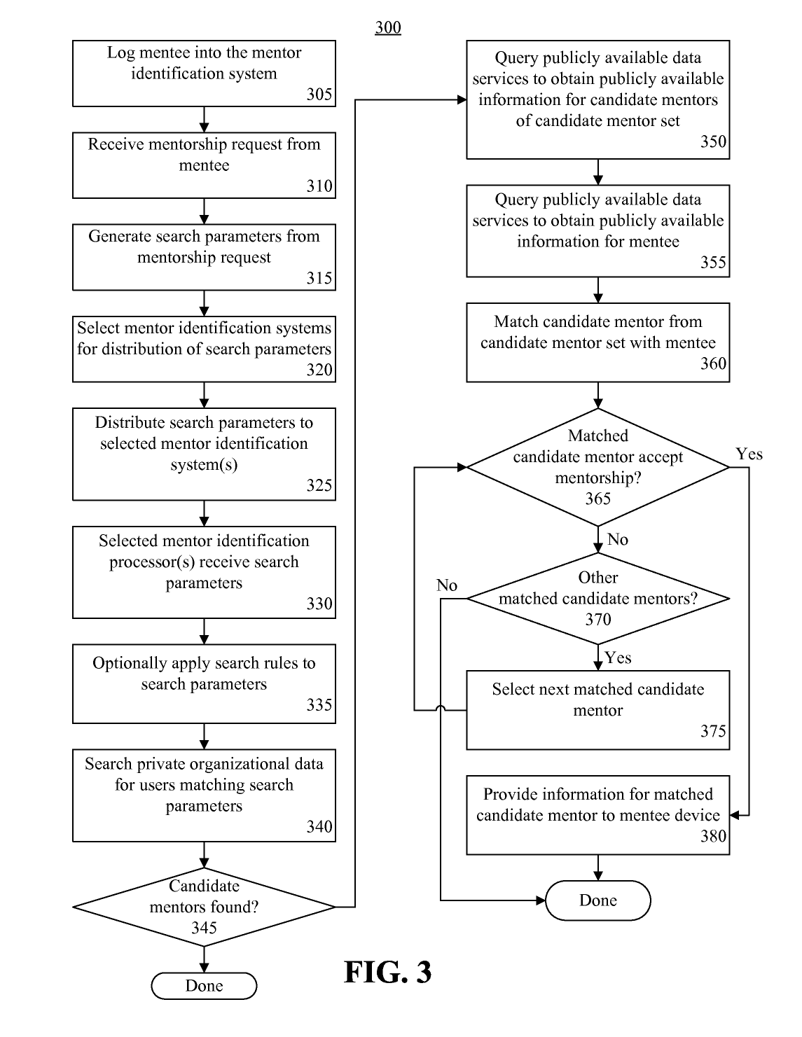

FIG. 3 is a flow chart illustrating an exemplary method 300 of mentor identification. Method 300 may be implemented using a system as described with reference to FIGS. 1 and 2 of this disclosure.

In block 305, the central request processor logs a user seeking a mentor into the mentor identification system. In block 310, the central request processor may receive a mentorship request from the mentee. The mentorship request may include natural language and or one or more other data items selected by the mentee through other user interface elements.

In block 315, the central request processor may generate one or more search parameters from the mentorship request. The central request processor, for example, may apply natural language understanding, semantic processing, or other known techniques for deriving meaning from natural language text, e.g., artificial intelligence, to determine the search parameters. The search parameters may include any data items that may have been selected by the mentee through the other user interface elements and may include an identity of the mentee as determined through the login process.

In block 320, the central request processor may select one or more mentor identification processors, from a plurality of such processors, to which the search parameters should be distributed. In one arrangement, the central request processor may compare the search parameters with stored descriptions of the different organizations at which each mentor identification processor has been installed. As noted, each mentor identification processor may be associated with a single organization. The central request processor may select those mentor identification processors installed at organizations determined to be related to one or more of the search parameters.

In block 325, the central request processor may distribute the search parameters to each selected mentor identification processor. In block 330, the selected mentor identification processor(s) may receive the search parameters. For purposes of discussion, the remainder of method 300 is described from the perspective of one mentor identification processor operating. It should be appreciated, however, that more than one mentor identification processor may be operating in parallel as described in the case where the central request processor selects more than one mentor identification processor.

In block 335, the mentor identification processor, e.g., the candidate discovery processor, optionally applies the search rules to the received search parameters. The search rules may modify the search parameters themselves, modify the results of the search, and/or control how the results of the search are interpreted. In block 340, the mentor identification system, e.g., the candidate discovery processor, searches the private data for the organization for users that match the search parameters, as modified by the search rules if applicable. In block 345, the candidate discovery processor may determine whether candidate mentors have been found. As noted, the determination of whether candidate mentors have been found may be performed in accordance with the search rules. If no candidate mentors have been found, the method may end.

If candidate mentors have been found, method 300 may continue. The candidate discovery processor may select a candidate mentor set that includes one or more candidate mentors from the private data of the organization or from a local cache of such data determined through data mining as described. Each candidate mentor within the candidate mentor set is a user within the organization that has agreed to serve as a mentor. In one aspect, the candidate discovery processor may select the candidate mentors of the candidate mentor set using only the private organizational data and the search parameters. The private organizational data is unavailable to the central request system and unavailable to the mentee.

In block 350, the mentor identification processor queries one or more publicly available data services to obtain publicly available information for each candidate mentor of the candidate mentor set. The candidate vetting processor may implement block 350. In block 355, the mentor identification processor queries one or more publicly available data services to obtain publicly available information for the mentee. The mentee vetting processor may implement block 355.

In block 360, the mentor identification processor may match a candidate mentor of the candidate mentor set with the mentee according to the publicly accessible information obtained in block 350 and/or 355. In one arrangement, the matching engine may compare the publicly available information for each candidate mentor and for the mentee with predefined criteria to identify any candidate mentors and/or a mentee that may pose a safety concern. In another arrangement, the matching engine may compare the search parameters with publicly available information for each of the candidate mentors of the candidate mentor set. In still another arrangement, the matching engine may verify and/or cross-reference publicly available information with the private organization data for each candidate mentor of the candidate mentor set. Similarly, the matching engine may verify and/or cross-reference search parameters from the mentee with the publicly available information for the mentee. In still another arrangement, the matching engine may compare the publicly available information for the mentee with the publicly available information for each candidate mentor.

In one aspect, the mentor identification processor may select the candidate mentor from the candidate mentor set that is determined to most closely match the mentee. For example, the mentor identification processor may score each candidate mentor of the candidate mentor set according to how closely the private organization data of the candidate mentor is determined to meet the search parameters of the mentee, how closely the publicly available information for the candidate mentor matches the search parameters, and/or how closely the publicly available information for the candidate mentor matches the publicly available information for the mentee. The mentor identification processor may choose the candidate mentor with the highest score as the matched candidate mentor.

In block 365 the mentor identification processor may determine whether the matched candidate mentor accepts the mentorship. The notification processor, for example, may send a message, such as an electronic mail, a text, or the like to a device of the matched candidate mentor or mentors as the case may be. The message may specify the identity of the mentee and circumstances of the mentorship. For example, the message may specify the mentorship request or portions thereof and/or search parameters. The matched candidate mentor may accept or decline the mentorship through his or her response via reply message.

Responsive to the notification processor determining that the matched candidate mentor accepted the mentorship, method 300 may proceed to block 380. Responsive to the mentor identification processor determining that the matched candidate mentor did not accept the mentorship, method 300 may continue to block 370.

In block 370, the notification processor may determine whether the candidate mentor set includes any other candidate mentors. If so, method 300 may continue to block 375 to select the next matching candidate mentor. If not, method 300 may end. In block 375, the notification processor may select the next candidate mentor of the candidate mentor set that matches, e.g., the next most closely matching candidate mentor.

In block 380, the notification processor may provide a mentor acceptance message to a device of the mentee. The mentor acceptance message may specify the identity of the mentor and contact information for the mentor so that the mentee may contact the mentor.

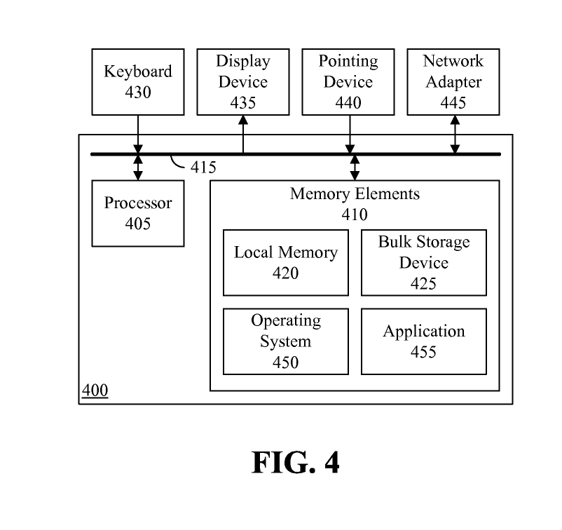

FIG. 4 is a block diagram illustrating an exemplary architecture 400 for a data processing system. Architecture 400 may be used to implement a computer that is suitable for storing and/or executing program code. It should be appreciated, however, that architecture 400 may be used to implement any system including a processor and memory that is capable of performing the operations described within this disclosure. In one aspect, for example, architecture 400 may be used to implement central request processor 110 of FIG. 1. In another aspect, architecture 400 may be used to implement a mentor identification system as described with reference to FIGS. 1, 2, and/or 3.

Architecture 400 includes at least one processor 405, e.g., a central processing unit (CPU), coupled to memory elements 410 through a system bus 415 or other suitable circuitry. Architecture 400 stores program code, e.g., a central request processing application and/or a mentor identification software architecture, within memory elements 410 as one or more applications 455. Processor 405 executes the program code accessed from memory elements 410 via system bus 415.

Memory elements 410 include one or more physical memory devices such as, for example, a local memory 420 and one or more bulk storage devices 425. Local memory 420 may be implemented as a random access memory (RAM) or other non-persistent memory device(s) generally used during actual execution of the program code. Bulk storage device 425 may be implemented as a hard disk drive (HDD), solid state drive (SSD), or other persistent data storage device. Architecture 400 also may include one or more cache memories (not shown) that provide temporary storage of at least some program code in order to reduce the number of times program code must be retrieved from the bulk storage device during execution.

Input/output (I/O) devices such as a keyboard 430, a display device 435, and a pointing device 440 optionally may be coupled to architecture 400. The I/O devices may be coupled to architecture 400 either directly or through intervening I/O controllers. A network adapter 445 may also be coupled to architecture 400 to enable a system implemented using architecture 400 to become coupled to other systems, computer systems, remote printers, remote storage devices through intervening private or public networks. Modems, cable modems, Ethernet cards, and wireless transceivers are examples of different types of network adapter 445 that may be used with architecture 400.

Memory elements 410 store an operating system 450 and application 455. In one aspect, application 255 may include one or more different program code modules. Application 455, being implemented in the form of executable program code, is executed by architecture 400. As such, application 455 is considered an integrated part of any system implemented using architecture 400. Application 455 and any data items used, generated, and/or operated upon by architecture 400 while executing application 455 are functional data structures that impart functionality when employed as part of architecture 400.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention.

For purposes of explanation, specific nomenclature is set forth to provide a thorough understanding of the various inventive concepts disclosed herein. The terminology used herein, however, is for the purpose of describing particular aspects of the inventive arrangements only and is not intended to be limiting.

As defined within this disclosure, the terms “a” and “an” mean one or more than one. The term “plurality,” as defined herein, means two or more than two. The term “another,” as defined herein, means at least a second or more. The term “coupled,” as defined herein, means connected, whether directly without any intervening elements or indirectly with one or more intervening elements, unless otherwise indicated. Two elements may also be coupled mechanically, electrically, or communicatively linked through a communication channel, pathway, network, or system.

As defined herein, the term “automatically” means without user intervention. As defined herein, the term “user” means a human being. The term “and/or” as defined herein means any and all possible combinations of one or more of the associated listed items. The terms “includes” and/or “including,” when used in this disclosure, specify the presence of stated features, integers, steps, operations, elements, and/or components, but do not preclude the presence or addition of one or more other features, integers, steps, operations, elements, components, and/or groups thereof. Although the terms “first,” “second,” etc. may be used herein to describe various elements, these elements should not be limited by these terms, as these terms are only used to distinguish one element from another unless the context indicates otherwise.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “if” means “when,” “upon,” “in response to determining,” “in response to detecting,” “responsive to determining,” or “responsive to detecting,” depending on the context. Similarly, the phrase “if it is determined” or the phrase “if [a stated condition or event] is detected,” as defined herein, means “upon determining,” “in response to determining,” “responsive to determining,” “upon detecting [the stated condition or event],” “in response to detecting [the stated condition or event],” or “responsive to detecting [the stated condition or event],” depending on the context.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
responsive to receiving a mentorship request comprising natural language, generating search parameters, using a central request processor, from the mentorship request, wherein the search parameters specify an identity of a mentee making the mentorship request;
distributing the search parameters to a mentor identification processor, wherein the mentor identification processor is implemented for a single organization and has access to a data system of the organization, wherein the data system stores private data of the organization unavailable to the central request system or the mentee;
selecting, using the mentor identification processor and from the private data of the organization, a candidate mentor set comprising at least one candidate mentor that meets the search parameters and that has agreed to serve as a mentor;
matching, using the mentor identification processor, a candidate mentor of the candidate mentor set with the mentee according to publicly accessible information retrieved for each candidate mentor of the candidate mentor set;
determining, using the mentor identification processor, whether a matched candidate mentor accepts selection for mentorship for the mentee; and
sending, using the mentor identification processor, a notification specifying the matched candidate mentor to a device of the mentee only responsive to determining that the matched candidate mentor accepts the mentorship.

2. The method of claim 1, further comprising:
selecting at least one mentor identification processor from a plurality of different mentor identification processors according to the mentorship request, wherein the search parameters are distributed to each selected mentor identification processor.

3. The method of claim 2, wherein each of the plurality of mentor identification processors is for a different organization and has access to private data for that organization.

4. The method of claim 1, wherein the candidate mentors of the candidate mentor set are selected by the mentor identification processor using only the private data of the organization.

5. The method of claim 1, further comprising:
querying at least one publicly accessible data service for the mentee; and
determining whether a query result for the mentee meets safety criteria.

6. The method of claim 1, wherein matching a candidate mentor of the candidate mentor set with the mentee according to publicly accessible information retrieved for each candidate mentor of the candidate mentor set comprises:
querying at least one publicly accessible data service for each candidate mentor; and
comparing a query result for each candidate mentor with the search parameters.

7. The method of claim 1, further comprising:
prior to selecting a candidate mentor that meets the search parameters and that has agreed to serve as a mentor, selectively modifying the query according to search rules specific to the mentor identification processor.

8. A system, comprising:
a processor programmed to initiate executable operations comprising:
responsive to receiving a mentorship request comprising natural language, generating search parameters from the mentorship request, wherein the search parameters specify an identity of a mentee making the mentorship request;
distributing the search parameters to a mentor identification processor, wherein the mentor identification processor is implemented for a single organization and has access to a data system of the organization, wherein the data system stores private data of the organization unavailable to the central request system or the mentee;
selecting, from the private data of the organization, a candidate mentor set comprising at least one candidate mentor that meets the search parameters and that has agreed to serve as a mentor;
matching a candidate mentor of the candidate mentor set with the mentee according to publicly accessible information retrieved for each candidate mentor of the candidate mentor set;
determining whether a matched candidate mentor accepts selection for mentorship for the mentee; and
sending a notification specifying the matched candidate mentor to a device of the mentee only responsive to determining that the matched candidate mentor accepts the mentorship.

9. The system of claim 8, wherein the processor is further programmed to initiate executable operations comprising:
selecting at least one mentor identification processor from a plurality of different mentor identification processors according to the mentorship request, wherein the search parameters are distributed to each selected mentor identification processor.

10. The system of claim 9, wherein each of the plurality of mentor identification processors is for a different organization and has access to private data for that organization.

11. The system of claim 8, wherein the candidate mentors of the candidate mentor set are selected by the mentor identification processor using only the private data of the organization.

12. The system of claim 8, wherein the processor is further programmed to initiate executable operations comprising:
querying at least one publicly accessible data service for the mentee; and
determining whether a query result for the mentee meets safety criteria.

13. The system of claim 8, wherein matching a candidate mentor of the candidate mentor set with the mentee according to publicly accessible information retrieved for each candidate mentor of the candidate mentor set comprises:
querying at least one publicly accessible data service for each candidate mentor; and
comparing a query result for each candidate mentor with the search parameters.

14. The system of claim 8, wherein the processor is further programmed to initiate executable operations comprising:
prior to selecting a candidate mentor that meets the search parameters and that has agreed to serve as a mentor, selectively modifying the query according to search rules specific to the mentor identification processor.

15. A computer program product comprising a computer readable storage medium having program code stored thereon, the program code executable by a processor to perform a method comprising:
responsive to receiving a mentorship request comprising natural language, generating search parameters, using a central request processor, from the mentorship request, wherein the search parameters specify an identity of a mentee making the mentorship request;
distributing the search parameters to a mentor identification processor, wherein the mentor identification processor is implemented for a single organization and has access to a data system of the organization, wherein the data system stores private data of the organization unavailable to the central request system or the mentee;
selecting, using the mentor identification processor and from the private data of the organization, a candidate mentor set comprising at least one candidate mentor that meets the search parameters and that has agreed to serve as a mentor;
matching, using the mentor identification processor, a candidate mentor of the candidate mentor set with the mentee according to publicly accessible information retrieved for each candidate mentor of the candidate mentor set;
determining, using the mentor identification processor, whether a matched candidate mentor accepts selection for mentorship for the mentee; and
sending, using the mentor identification processor, a notification specifying the matched candidate mentor to a device of the mentee only responsive to determining that the matched candidate mentor accepts the mentorship.

16. The computer program product of claim 15, further comprising:
selecting at least one mentor identification processor from a plurality of different mentor identification processors according to the mentorship request, wherein the search parameters are distributed to each selected mentor identification processor.

17. The computer program product of claim 16, wherein each of the plurality of mentor identification processors is for a different organization and has access to private data for that organization.

18. The computer program product of claim 15, wherein the candidate mentors of the candidate mentor set are selected by the mentor identification processor using only the private data of the organization.

19. The computer program product of claim 15, wherein matching a candidate mentor of the candidate mentor set with the mentee according to publicly accessible information retrieved for each candidate mentor of the candidate mentor set comprises:
querying at least one publicly accessible data service for each candidate mentor; and
comparing a query result for each candidate mentor with the search parameters.

20. The computer program product of claim 15, further comprising:
prior to selecting a candidate mentor that meets the search parameters and that has agreed to serve as a mentor, selectively modifying the query according to search rules specific to the mentor identification processor.
